(19) United States
(12) Patent Application Publication
(10) Pub. No.: US 2018/0359988 A1
(43) Pub. Date: Dec. 20, 2018

(54) MISCANTHUS ABSORBENT PRODUCT AND METHODS OF PRODUCING THE SAME

(71) Applicant: Aloterra, LLC, The Woodlands, TX (US)

(72) Inventors: Jon Griswold, The Woodlands, TX (US); Matt Griswold, The Woodlands, TX (US); Scott Coye-Huhn, The Woodlands, TX (US)

(21) Appl. No.: 16/008,555

(22) Filed: Jun. 14, 2018

Related U.S. Application Data
(60) Provisional application No. 62/519,256, filed on Jun. 14, 2017.

(51) Int. Cl. A01K 1/015; B01J 20/28; B01J 20/30

(52) U.S. Cl. CPC A01K 1/0155; B01J 20/28004; B01J 2220/485; B01J 20/3078; B01J 20/3021

(57) ABSTRACT

Described is a natural absorbent product. In particular, the described is a miscanthus absorbent product made from densified miscanthus have a density is a range from 17 lbs./ft.3 to 29 lbs./ft.3 and a mean particle size in a range from 0.6 mm to 0.8 mm. Also described are methods of producing of miscanthus absorbent product. The method includes chopping miscanthus stalks to a desired length, processing the chopped miscanthus to break apart the chopped miscanthus, pelletizing the processed miscanthus, and reducing the size of the miscanthus pellets to result in a product having a desired mean particle size.

### RELATED APPLICATION

The present application is a non-provisional patent application claiming priority to U.S. Provisional Patent Application No. 62/519,256 filed Jun. 14, 2017, the disclosure of which is hereby incorporated by reference herein in its entirety.

### FIELD

The present invention is directed to plant based absorbent materials, and particularly directed to miscanthus absorbent materials and method of making the same.

### BACKGROUND

Millions of minor and major spills occur in the United States every day. These incidents have an enormous range of fact patterns that cover fluid loss in automobile accidents, minor and major spills in commercial, industrial, and manufacturing operations, and incidents in U.S. households during home repair, car repair, or a multitude of other activities.

These spills can expose humans to a multitude of risks that include physical injury via slips, falls, and chemical exposure, and can also result in the environment being negatively impacted if not properly contained. OSHA injury statistics establish that falls on wet surfaces are a significant source of lost work time, which means the economic impact is both enormous and preventable. Importantly, the act of cleaning up spills is itself a source of concern as it requires the hauling and storage of an absorbent product, the application of the product, and the hauling away of the used product to complete the cleanup of a spill.

Absorbent materials are also used as animal bedding and litter products. Animal handling facilities, such as labs, as well as pet owners are seeking natural alternatives to bedding and litter products that are biodegradable and have higher absorbency than today's options.

The current absorbent products available in markets today, mineral based kitty litter type products, have one or more critical flaws. Specifically, existing natural absorbents are low quality and only absorb ½ times or 1 times their weight in liquid. When cleaning up a spill, the low absorbency of the existing absorbent products mean that significant quantities of the absorbent product will be needed to clean up even a moderately sized spill. Additional, the low absorbency of existing products requires more handling, storage, and hauling expenses, and could result in additional lost production time in the workforce.

Plant based absorbent products, such as recycled paper based products and products made from wood and other fibrous plants each have one or both critical deficiencies of poor absorbency or low bulk density that prevents significant market availability.

The other absorbent products are petroleum based (i.e., polymeric absorbents), making them very expensive with potential health impacts via their application and use. Polymeric absorbents are also limited in that they typically can only absorb certain liquids.

The market needs a safe, natural, and high quality absorbent that can be economically transported and is not limited by low bulk density and high transport costs.

### SUMMARY

Miscanthus is a non-invasive perennial grass that is a highly sustainable crop that only needs to be planted once in its 20 plus year life cycle. In an exemplary embodiment, the miscanthus is Miscanthus x. giganteus. The Miscanthus crop reduces soil erosion, uses zero pesticides, only requires herbicides in its first two years, sequesters carbon, requires very little fertilizer, is drought resistant, and is able to grow on fields with marginal soils and bring those fields back to a condition for commercial agricultural production.

Miscanthus-based absorbent products prepared in accordance with embodiments of the invention are 100% natural, safe to use, biodegradable, and highly absorbent. For example, embodiments of the present miscanthus-based absorbent products can absorb 5 times their weight in aqueous liquids and 4 times their weight in petroleum and other oil-based liquids. Embodiments of the miscanthus-based absorbent products may also be manufactured in a manner that provides sufficient bulk density to be economically transported to a wide geographic region. In use, embodiments of the miscanthus based absorbent products can be used to absorb spills, as animal bedding, and as kitty litter.

An aspect of the invention is directed to a miscanthus absorbent product made from densified miscanthus. In an embodiment, the miscanthus absorbent product has a density in a range from 17 lbs./ft.3 to 29 lbs./ft.3 and a mean particle size in a range from 0.6 mm to 0.8 mm.

Another aspect of the invention is directed to methods of producing of miscanthus absorbent product. An embodiment of the method includes chopping miscanthus stalks to a desired length, processing the chopped miscanthus to break apart the chopped miscanthus, pelletizing the processed miscanthus, and reducing the size of the miscanthus pellets to result in a product having a desired mean particle size.

### BRIEF DESCRIPTION OF THE DRAWINGS

The accompanying drawings, which are incorporated in and constitute a part of this specification, illustrate an embodiment of the invention and together with the general description of the invention given above and the detailed description of the embodiment given below, serve to explain the principles of the present invention.

FIG. 1 is a flow chart showing the process for producing a product in accordance with the principles of the present invention; and

FIG. 2 is a graph showing particle size distribution in accordance with the principles of the present invention.

### DETAILED DESCRIPTION

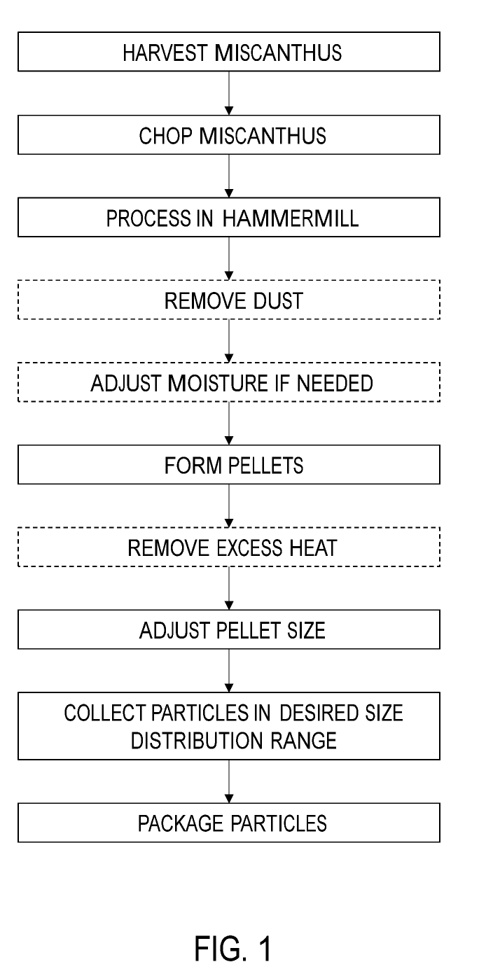

With reference to FIG. 1, miscanthus is harvested (Box 10) and chopped prior to further processing (Box 12). In an embodiment, the miscanthus is chopped to a consistent average length that ranges between 5 mm and 100 mm, and alternatively, a length that ranges between 5 mm and 50 mm, and alternatively, a length that ranges between 5 mm and 25 mm, and alternatively, a length that ranges between 5 mm and 15 mm, and further alternatively, a length of 10 mm. In an embodiment, the raw miscanthus material is chopped to the desired length during the harvesting process, such as with a silage chopper. In another embodiment, the harvested miscanthus is baled during harvesting and chopped to the desired length prior processing. In the latter instance, miscanthus can be chopped down to the desired size in a chopper, such as a silage chopper.

After chopping to the desired length, the chopped miscanthus is processed in a hammermill (Box 14). For example, the chopped miscanthus can be delivered to the hammermill by a conveyor system that feeds directly into the hammermill. Chopping the miscanthus to the recited size ranges improves the processing of the miscanthus in the hammermill. If the miscanthus is too long, such as longer than a length of 50 mm, the operating efficiency of the hammermill decreases. If the material is too small entering the hammermill it can result in the fiber and pith being destroyed, thereby having a negative impact on the absorbency of the final product.

The hammermill is a cylindrical processing chamber, a rotor made of solid, and all faces machined hardened steel discs and racket of sharp-edged material. An exemplary hammermill suitable for processing the chopped miscanthus is the Champion 4844 with 300 hp motor. The length and composition of the miscanthus materials exiting the hammermill will be optimized for absorbent pelletizing when using screen sizes in ranges between ½ in. (12.7 mm) and 5/32 in. (3.96 mm), and alternatively, a screen size of 3/16 in. (4.76 mm).

The hammered miscanthus material is then conveyed, such as by a conveyor belt, to a cyclone wherein the heavy particles and dust particles are separated (Box 16). The cleaned material comprising the heavier particles from the cyclone may then be stored, such as in a surge bin or holding tank, or conveyed immediately for further processing.

The moisture content of the material may be determined and if moisture is needed to make the pellet, water is added (Box 18). In an embodiment, the moisture content of the cleaned material is in a range from 5% to 12%. In an embodiment, water needed to bring the moisture content within the desired range is added to the cleaned material as it is transported along a conveyor cyclone or surge bin to the pellet mill.

The material is pelletized in a standard pellet mill, such as a California Pellet Mill, using a pellet die that results in the formation of a pellet having a diameter of 3/16 inch to ½ inch, lengths of 1½ inch to 3 inches, and a density in a range from 20 lbs per cubic foot to 43 lbs per cubic foot (Box 20). In another embodiment, the pellets have a density in a range from 25 lbs per cubic foot to 43 lbs per cubic foot. In another embodiment, the pellets have a range from 25 lbs per cubic foot to 41 lbs per cubic foot. Without being bound to a particular theory, the combination of the relatively large size and the relatively low density of the resulting pellets reduces the destruction of the fibers and associated structure from the miscanthus material. While the pellet is not required to have a minimum durability, the resulting pellets may have a durability in a range from 60 Pellet Durability Index (PDI) to 95 PDI. Durability may be determined according to the method set forth in Kansas State University—Mechanical Durability of Feed Pellets, Call Number: LD2668.T4 1962 Y68. The durability of the pellet may affect the absorbency and bulk density of the finished product and impact the economics of transporting the finished product.

In an embodiment, the pellets are transported, such as by a conveyor belt, through a heat exchanger to remove excess heat that results from the pelleting process prior to the sizing step in the process (Box 22). An exemplary cooler is a counter-current cooler. In another embodiment, the pellets are transported directly to the sizing step without cooling.

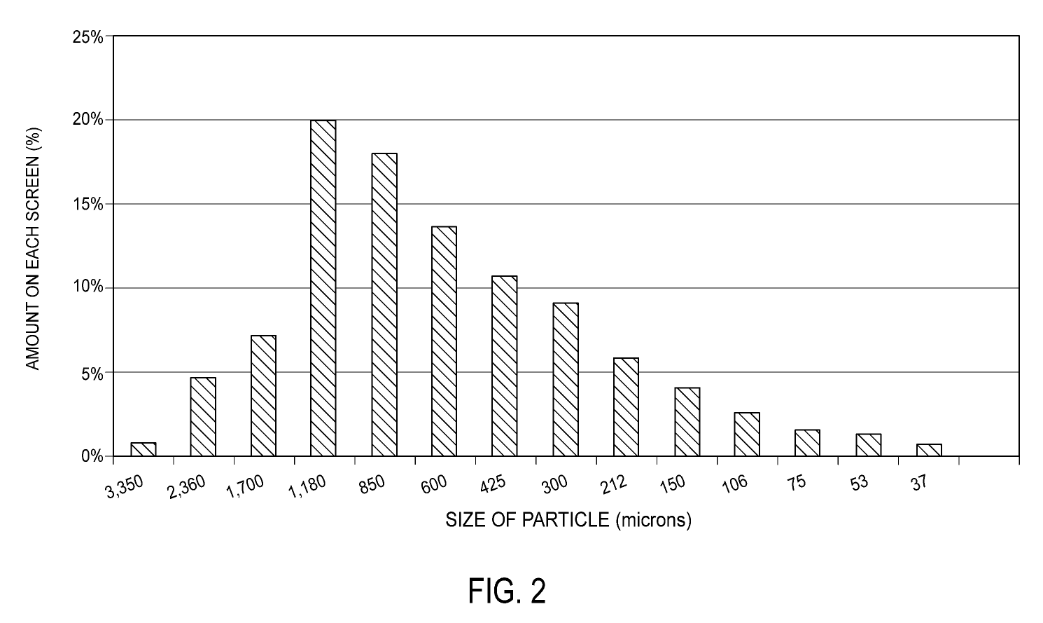

For the sizing step, the pellets enter a sizing unit. In an embodiment, the sizing unit is a crumbler or a roller mill (Box 24). The sizing unit reduces the size of the pellets to result in a particle having a particle distribution that ranges from 0.6 to 0.85. An exemplary particle distribution is as set out in FIG. 2. In an exemplary embodiment, the sizing unit is a roller mill with two rolls set at a 5/5 roll gap, with roller one RM 900-12 5/5 5 degree horizontal set roll gap of 0.0515 inches operating at 600 rpm, and roller two RM 900-12 10/12 5 degree horizontal set roll gap of 0.00013 inches operating at 400 rpm, that results in a product having a bulk density in a range that results in sufficient absorbency while not being easily blown around and difficult to handle. In an embodiment, the product has a bulk density in a range from 19 lbs./ft.³ to 29 lbs./ft.³ or in a range from 20 lbs./ft.³ to 25 lbs./ft.³ with the desired mean particle size. In alternative embodiments, the desired particle size may be achieved using various settings in the roller mill and roller types or other sizing technologies as are known in the art, such as a pin mill.

Embodiments of the absorbent product includes sized particles that are generally spherical, which includes spherical-shaped particles, oblong particles, such as egg-shaped particles, hemispherical-shaped particles, and combinations thereof. Alternative embodiments of the sized particles are irregular shaped and may include cylindrical particles, spherical particles, hemispherical-shaped particles, cone-shaped particles, and combinations thereof.

In embodiments of the invention, dust, i.e., particles having a size less than the size of the particles at the lower end of the desired particle distribution, is removed from the product, i.e., the particles having the desired particle distribution and bulk density (Box 26). In an exemplary embodiment, dust is removed by transporting the product on a conveyor belt assembly while the product is screened and vacuumed. The product, with excess dust removed, is then transported to a bagging unit for final packaging (Box 28) and palletizing for storage, transport, and sale. In an alternative embodiment, dust is not removed from the product before being transported to a bagging unit for final packaging and palletizing for storage, transport, and sale.

The product, i.e., the particles having the desired particle distribution and bulk density, has a dry matter content of 90-97%. The appearance of the product may be brown to light beige, depending on the composition of the starting materials. The bulk density of the product ranges from 15 to 30 pounds per square foot.

It has been observed through significant experimentation that maximum absorbency is achieved in product having a mean particle size of 0.6 mm to 0.8 mm with greater absorbency being achieved in a product have a mean particle size of 0.7 mm to 0.78 mm and optimal absorbency is attained in a product with a mean particle size in a range from 0.72 mm and 0.74 mm. Accordingly, in an embodiment, the mean particle size of the absorbent product is in a range from 0.6 mm to 0.8 mm. In another embodiment, the mean particle size of the absorbent product is in a range from 0.7 mm to 0.78 mm. In another embodiment, the mean particle size of the absorbent product is in a range from 0.72 mm and 0.74 mm. The graph in FIG. 2 illustrates an exemplary mean particle distribution that achieves an average of 0.72 mm, but in other embodiments of the invention, this optimal absorbency is achieved with a tighter mean particle distribution.

Embodiments of the absorbent products may absorb more than two time their weight in aqueous fluids and oil-based fluids. Further embodiments may absorb between two times their weight and six times their weight in aqueous fluids and between two times and five time their weight in oil-based liquids. Further embodiments may absorb five times their weight in aqueous liquids and four times their weight in oil-based liquids. Embodiments of the miscanthus absorbent products may be used to clean up spills, as animal bedding, as kitty litter or combinations thereof.

While the present invention has been illustrated by a description of a particular embodiment thereof, and while the embodiment has been described in some detail, it is not intended to restrict or in any way limit the scope of the appended claims to such detail. Additional advantages and modifications will readily appear to those skilled in the art. The invention in its broader aspects is therefore not limited to the specific details, representative apparatus and method shown and described. Accordingly, departures may be made from such details without departing from the scope or spirit of the general inventive concept.

What is claimed is:

1. A method of producing of miscanthus absorbent product comprising:
chopping miscanthus stalks to a desired length;
processing the chopped miscanthus to break apart the chopped miscanthus;
pelletizing the processed miscanthus;
reducing the size of the miscanthus pellets to result in a product having a desired mean particle size.

2. The method of claim 1 wherein the desire length is in a range from 5 mm to 100 mm.

3. The method of claim 1 wherein the desired length is in a range from 5 mm to 15 mm.

4. The method of claim 1 wherein the processing step includes running the chopped miscanthus through a hammer mill.

5. The method of claim 1 wherein the pelletizing step results in a pellet having a bulk density in a range from 19 lbs./ft.³ to 29 lbs./ft.³.

6. The method of claim 1 wherein the pelletizing step results in a pellet having a diameter in a range from 3/16 to ½ inch.

7. The method of claim 1 wherein the pelletizing step results in a pellet having a length in a range from 1½ to 3 inches.

8. The method of claim 1 wherein the pelletizing step results in a pellet having a durability in a range from 60 to 95.

9. The method of claim 1 wherein the reducing step results in particles that are generally spherical.

10. The method of claim 9 wherein the generally spherical particles are spherical, egg-shaped, hemispherical, or combinations thereof.

11. The method of claim 1 wherein the reducing step includes running the pellets through a roller mill.

12. The method of claim 1 wherein the desired mean particle size is in a range from 0.6 mm to 0.8 mm.

13. The method of claim 1 wherein the desire mean particle size is in a range from 0.7 mm to 0.78 mm.

14. The method of claim 1 wherein the desired mean particle size is in a range from 0.72 mm to 0.74 mm.

15. A miscanthus absorbent product formed from the method of claim 1.

16. A miscanthus absorbent product comprising densified miscanthus have a density is a range from 17 lbs./ft.³ to 29 lbs./ft.³ and a mean particle size in a range from 0.6 mm to 0.8 mm.

17. The miscanthus absorbent product of claim 17 wherein the mean particle size is in a range from 0.7 mm to 0.78 mm.

18. The miscanthus absorbent product of claim 18 wherein the mean particle size is in a range from 0.72 mm to 0.78 mm.
